(19) United States
(12) Patent Application Publication
(10) Pub. No.: US 2013/0173031 A1
(43) Pub. Date: Jul. 4, 2013

(54) COMPUTER NUMERICAL CONTROL MACHINE AND CONTROL METHOD

(71) Applicants: SHOU-MING LIANG, Tu-Cheng (TW); YUEH-HSUN KING, Tu-Cheng (TW)

(72) Inventors: SHOU-MING LIANG, Tu-Cheng (TW); YUEH-HSUN KING, Tu-Cheng (TW)

(73) Assignee: FOXNUM TECHNOLOGY CO., LTD., Tu-Cheng (TW)

(21) Appl. No.: 13/456,244

(22) Filed: Apr. 26, 2012

(30) Foreign Application Priority Data
Dec. 28, 2011 (TW) 100149069

(51) Int. Cl. G05B 19/18

(52) U.S. Cl. 700/83

(57) ABSTRACT

A Computer numerical control (CNC) machine includes a body; a touch screen, to display information and sense touch input of a user; and a processing unit, to obtain user information when the user logs in the CNC machine, generate a visual menu on the touch screen corresponding to the user information, and control the body to perform functions according to the touch input on the visual menu. A control method is also provided.

### BACKGROUND

1. Technical Field

The present disclosure relates to computer numerical control (CNC) machines and control methods, and more particularly, to a CNC machine with a visual operational panel and a control method for the CNC machine.

2. Description of Related Art

Computer numerical control (CNC) machines usually have a keyboard or input/output (I/O) board as a mechanical operational panel. However, the keyboard and the I/O board cannot set different privileges according to different users, in addition, when the CNC machine needs to update to a new version of the software, the operational panel corresponding to the old version will have to be replaced, which wastes resources and is inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a block diagram of one embodiment of a CNC machine in accordance with the present disclosure.

FIG. 2 is a flowchart of method for controlling the CNC machine in FIG. 1, in a first embodiment.

FIG. 3 is a flowchart of method for controlling the CNC machine in FIG. 1, in a second embodiment.

### DETAILED DESCRIPTION

Embodiments of the present disclosure will be described below, with reference to the accompanying drawings.

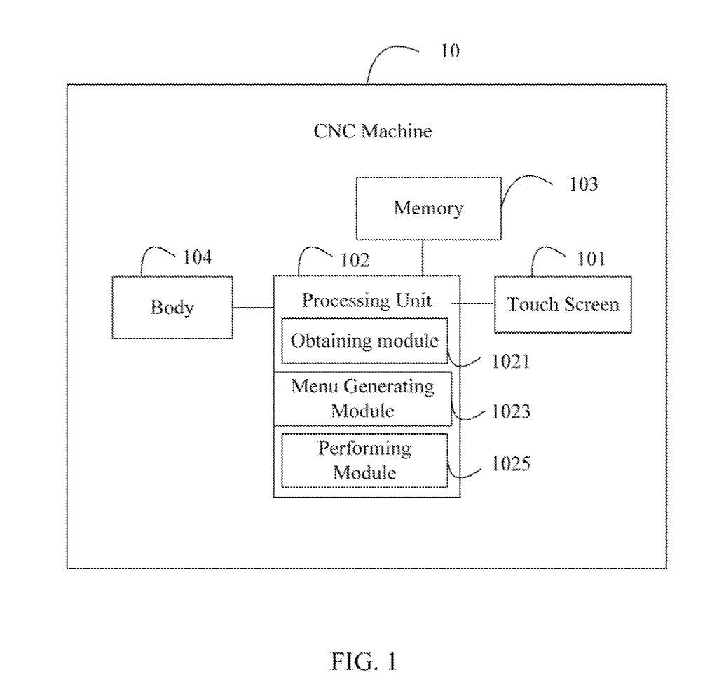

FIG. 1 is a block diagram of one embodiment of a CNC machine in accordance with the present disclosure. The CNC machine 10 includes a touch screen 101, a processing unit 102, a memory 103, and a body 104.

The touch screen 101 displays information and senses the touch input of a user. The memory 103 stores data. In a first embodiment, the data includes a number of user information corresponding to different users and a number of virtual menus corresponding to the number of user information. The user information defines a level of permission given to different users to manipulate the CNC machine 10. For example, an operator is permitted to only manipulate the CNC machine 10, a system administer is permitted to modify system settings such as modifying operational parameters of the CNC machine 10.

In a second embodiment, the data includes information of operation modes and operation status and the number of virtual menus corresponding to the information of the operation modes and the operation status. The operation mode includes manual operation and edit operation, for example. The operation status includes working and suspending, for example. The operation mode and the operation status may be pre-selected by the user through the touch screen 101, and then stored in the memory 103.

The virtual menu includes a number of icons to indicate to the user to touch for manipulation. The processing unit 102 controls the body 104 to perform functions of the icon on the virtual menu after the user touches the icon.

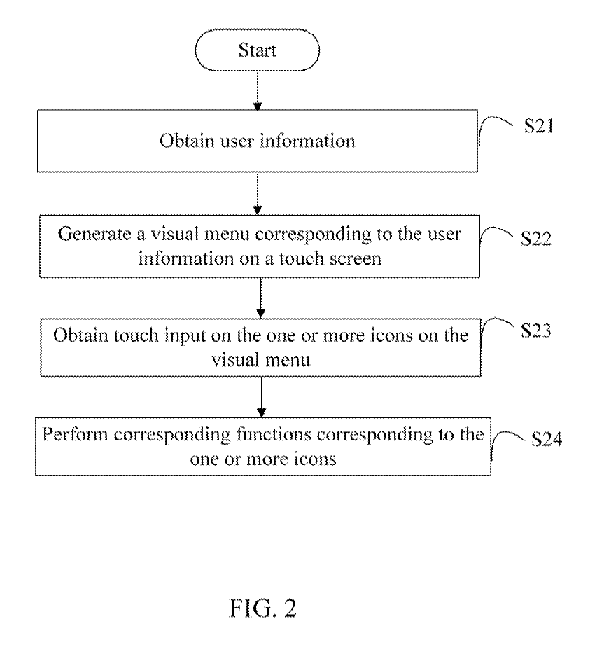

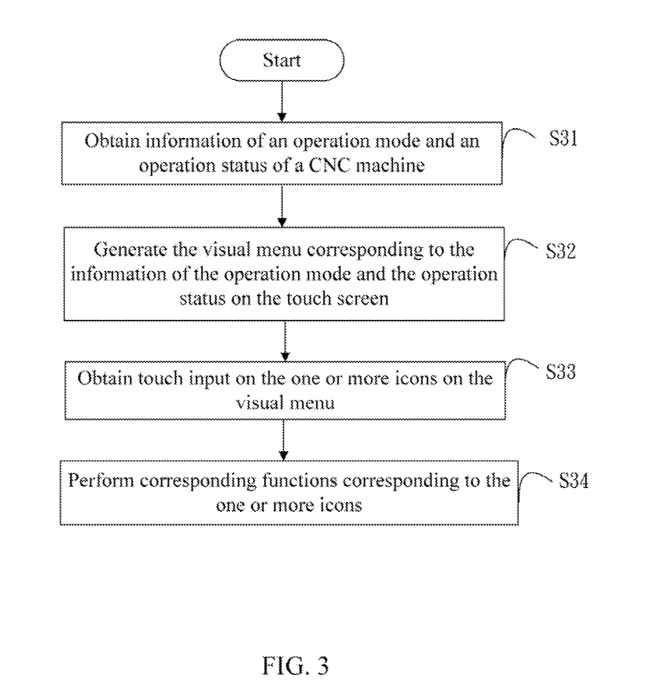

The processing unit includes an obtaining module 1021, a menu generating module 1023, and a performing module 1025. Functions of the modules will be described together with FIG. 2 and FIG. 3.

FIG. 2 is a flowchart of method for controlling the CNC machine in FIG. 1, in a first embodiment. In step S21, the obtaining module 1021 obtains the user information from the memory 103 when the user logs in the CNC machine 10.

In step S22, the menu generating unit 1023 connects with the touch screen 101, generates a visual menu corresponding to the user information on the touch screen 101.

In step S23, the obtaining module 1021 obtains the touch input on the one or more icons on the visual menu from the touch screen 101.

In step S24, the performing module 1025 responds to the touch input on the one or more icons on the visual menu and controls the body 104 to perform corresponding functions corresponding to the one or more icons on the visual menu.

FIG. 3 is a flowchart of method for controlling the CNC machine in FIG. 1, in a second embodiment. In step S31, the obtaining module 1021 obtains information of the operation mode and the operation status of the CNC machine 10 from the memory 103.

In step S32, the menu generating unit 1023 generates the visual menu corresponding to the information of the operation mode and the operation status on the touch screen 101.

In step S33, the obtaining module 1021 obtains the touch input on the one or more icons on the visual menu from the touch screen 101.

In step S34, the performing module 1025 responds to the touch input on the one or more icons on the visual menu and controls the body 104 to perform corresponding functions corresponding to the one or more icons on the visual menu.

Using the method above, the CNC machine 10 generates visual menus on the touch screen 101 to indicate to the user to manipulate the CNC machine 10, furthermore, different users have different operation modes and operation status corresponding to different visual menus, which saves resources and is convenient to use.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A Computer numerical control (CNC) machine comprising:
a body;
a touch screen, to display information and sense touch input of a user; and
a processing unit, to obtain user information when the user logs in the CNC machine, generate a visual menu on the touch screen corresponding to the user information, and control the body to perform functions according to the touch input on the visual menu.

2. The CNC machine of claim 1, further comprising a memory for storing user information corresponding to different users and a plurality of virtual menus corresponding to the user information, wherein the processing unit obtains the user information from the memory, and obtains the visual menu corresponding to obtained user information from the plurality of virtual menus and generates the visual menu corresponding to the user information on the touch screen.

3. The CNC machine of claim 1, wherein the user information defines a level of permission given to different users to manipulate the CNC machine.

4. A Computer numerical control (CNC) machine comprising:
a body;
a touch screen, to display information and sense touch input of a user; and
a processing unit, to obtain information of an operation mode and an operation status of the CNC machine when a user logs in the CNC machine, generate a visual menu corresponding to the information of the operation mode and the operation status on the touch screen, and control the body to perform functions according to the touch input on the visual menu.

5. The CNC machine of claim 1, further comprising a memory for storing the information of operation modes and operation status and the plurality of virtual menus corresponding to the information of the operation modes and the operation status, wherein the processing unit obtains the information of an operation mode and an operation status of the CNC machine from the memory, and obtains the visual menu corresponding to the information of the operation modes and the operation status from the plurality of virtual menus and generates the visual menu corresponding to the information of the operation modes and the operation status on the touch screen.

6. The CNC machine of claim 5, wherein the operation mode and the operation status are pre-selected by the user through the touch screen, and stored in the memory.

7. The CNC machine of claim 4, wherein the operation mode further comprises manual operation and edit operation, and the operation status further comprises working and suspending.

8. A control method implemented by a Computer numerical control (CNC) machine, the control method comprising:
obtaining user information when the user logs in the CNC machine;
generating a visual menu on a touch screen corresponding to the user information; and
controlling the body to perform functions according to the touch input on the visual menu.

9. The control method of claim 9, wherein the CNC machine comprises a memory for storing user information corresponding to different users and a plurality of virtual menus corresponding to the user information, the method further comprises obtaining the user information from the memory, and obtaining the visual menu corresponding to obtained user information from the plurality of virtual menus and generating the visual menu corresponding to the user information on the touch screen.

10. The control method of claim 9, wherein the user information defines a level of permission given to different users to manipulate the CNC machine.

11. A control method implemented by a Computer numerical control (CNC) machine, the control method comprising:
obtaining information of an operation mode and an operation status of the CNC machine;
generating a visual menu corresponding to the information of the operation mode and the operation status on the touch screen; and
controlling the body to perform functions according to the touch input on the visual menu

12. The control method of claim 11, wherein the CNC machine comprises a memory for storing the information of operation modes and operation status and a plurality of virtual menus corresponding to the information of the operation modes and the operation status, the method further comprises obtaining the information of operation modes and operation status from the memory, and obtaining the visual menu corresponding to obtained information of operation modes and operation status from the plurality of virtual menus and generating the visual menu corresponding to the obtained information of operation modes and operation status on the touch screen.

13. The control method of claim 12, further comprising step of pre-selecting the operation mode and the operation status through the touch screen, and storing in the memory.

14. The control method of claim 11, wherein the operation mode further comprises manual operation and edit operation, and the operation status further comprises working and suspending.
